(19) United States
(12) Patent Application Publication
(10) Pub. No.: US 2018/0307615 A1
(43) Pub. Date: Oct. 25, 2018

(54) STORAGE CONTROL APPARATUS AND STORAGE CONTROL METHOD

(71) Applicant: FUJITSU LIMITED, Kawasaki-shi (JP)

(72) Inventors: Naohiro Takeda, Zushi (JP); Norihide KUBOTA, Kawasaki (JP); YOSHIHITO KONTA, Kawasaki (JP); Yusuke Kurasawa, Nagano (JP); Toshio Kikuchi, Sagamihara (JP); Yuji TANAKA, Inagi (JP); Marino Kajiyama, Yokohama (JP); Yusuke Suzuki, Kawasaki (JP); YOSHINARI SHINOZAKI, Kawasaki (JP); Takeshi WATANABE, Kawasaki (JP); Noriyuki Yasu, Kawasaki (JP)

(73) Assignee: FUJITSU LIMITED, Kawasaki-shi (JP)

(21) Appl. No.: 15/952,292

(22) Filed: Apr. 13, 2018

(30) Foreign Application Priority Data
Apr. 20, 2017 (JP) 2017-083903

(51) Int. Cl. G06F 12/10; G06F 3/06

(52) U.S. Cl. CPC G06F 12/10; G06F 3/0616; G06F 3/064; G06F 2212/202; G06F 3/0664; G06F 3/0683; G06F 2212/1036; G06F 3/0656

(57) ABSTRACT

A storage control apparatus configured to control a storage device including a storage medium having a limited number of writes, includes a memory, and a processor coupled to the memory and configured to store, in the memory, address conversion information associating logical addresses used for data identification by an information processing apparatus accessing to the storage device, and physical addresses indicating positions where the data is stored on the storage medium, write the data additionally and collectively to the storage medium, and when the data is updated, maintain storing a reference logical address associated with the data before updated and the data before updated on the storage medium.

### CROSS-REFERENCE TO RELATED APPLICATION(S)

This application is based upon and claims the benefit of priority of the prior Japanese Patent Application No. 2017-83903, filed on Apr. 20, 2017, the entire contents of which are incorporated herein by reference.

### FIELD

The embodiment discussed herein is related to a storage control apparatus and a storage control method.

### BACKGROUND

Recently, the storage media of storage apparatus is shifting from hard disk drives (HDDs) to flash memory such as solid-state drives (SSDs) with faster access speeds. In an SSD, memory cells are not overwritten directly. Instead, data is written after deleting data in units of blocks having a size of 1 megabyte (MB), for example.

For this reason, in the case of updating some of the data within a block, the other data within the block is evacuated, the block is deleted, and then the evacuated data and the updated data are written. For this reason, the process of updating data which is small compared to the size of a block is slow. In addition, SSDs have a limited number of writes. For this reason, in an SSD, it is desirable to avoid updating data which is small compared to the size of a block as much as possible. Accordingly, in the case of updating some of the data within a block, the other data within the block and the updated data are written to a new block.

Note that with regard to flash memory, there is technology that executes a regeneration process of reverting a physical unit region back to the initial state when the difference between a usage level, which is a running count of logical addresses stored in a management information storage region inside the physical unit region, and a duplication level, which is the number of valid logical addresses, exceeds a predetermined value. According to this technology, it is possible to utilize flash memory effectively while also potentially extending the life of the flash memory.

In addition, there is technology that writes one or more pieces of surviving data inside one or more selected copy source physical regions in units of strips or units of stripes, sequentially from the beginning of a free region of a selected copy destination physical region. With this technology, in the case in which the size of the data to write does not satisfy a size desired for writing in units of strips or units of stripes, the data to write is padded to thereby improve garbage collection (GC) performance.

For examples of technologies of the related art, refer to Japanese Laid-open Patent Publication No. 2009-87021 and International Publication Pamphlet No. WO 2016/181481.

### SUMMARY

According to an aspect of the invention, a storage control apparatus configured to control a storage device including a storage medium having a limited number of writes, includes a memory, and a processor coupled to the memory and configured to store, in the memory, address conversion information associating logical addresses used for data identification by an information processing apparatus accessing to the storage device, and physical addresses indicating positions where the data is stored on the storage medium, write the data additionally and collectively to the storage medium, and when the data is updated, maintain storing a reference logical address associated with the data before updated and the data before updated on the storage medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage configuration of a storage apparatus according to an embodiment;

FIG. 2 is a diagram illustrating the format of a RAID unit;

FIGS. 3A to 3C are diagrams illustrating the format of reference metadata;

FIG. 4 is a diagram illustrating the format of logical/physical metadata;

FIGS. 5A to 5D are diagrams for describing a meta-metadata scheme according to an embodiment;

FIG. 6 is a diagram illustrating the format of a meta-address;

FIG. 7 is a diagram illustrating an exemplary arrangement of RAID units in a drive group;

FIG. 8 is a diagram illustrating the configuration of an information processing system according to an embodiment;

FIG. 9 is a diagram for describing GC polling in pool units;

FIG. 10 is a diagram for describing the appending of valid data;

FIGS. 11A and 11B are diagrams illustrating the format of an RU management table;

FIG. 12 is a diagram for describing a method of determining data validity using reference metadata;

FIG. 13 is a diagram illustrating relationships among functional units;

FIG. 14 is a flowchart illustrating the flow of GC polling;

FIG. 15 is a diagram illustrating the sequence of a process of computing an invalid data ratio;

FIG. 16 is a flowchart illustrating the flow of a validity check process for a user data unit;

FIG. 17 is a flowchart illustrating the flow of a validity check process for logical/physical metadata; and

FIG. 18 is a diagram illustrating the hardware configuration of a storage control apparatus that executes a storage control program according to an embodiment.

### DESCRIPTION OF EMBODIMENTS

In the case of updating some of the data in a physical region, such as a block, if the other data in the physical region and the updated data are written to a new physical region, GC is performed with respect to the old physical region that stores the outdated data. However, determining whether or not a certain physical region is invalid involves inspecting all conversion information that converts logical addresses into physical addresses and determining if a logical region referencing the relevant physical region exists. For this reason, there is the problem of a large load imposed by the determination process.

In one aspect of the present disclosure, an objective is to reduce the load of the process for determining whether or not a physical region is invalid.

Hereinafter, an embodiment of a storage control apparatus, a storage control method, and a storage control program disclosed in this specification will be described in detail based on the drawings. However, the embodiment does not limit the disclosed technology.

### Embodiment

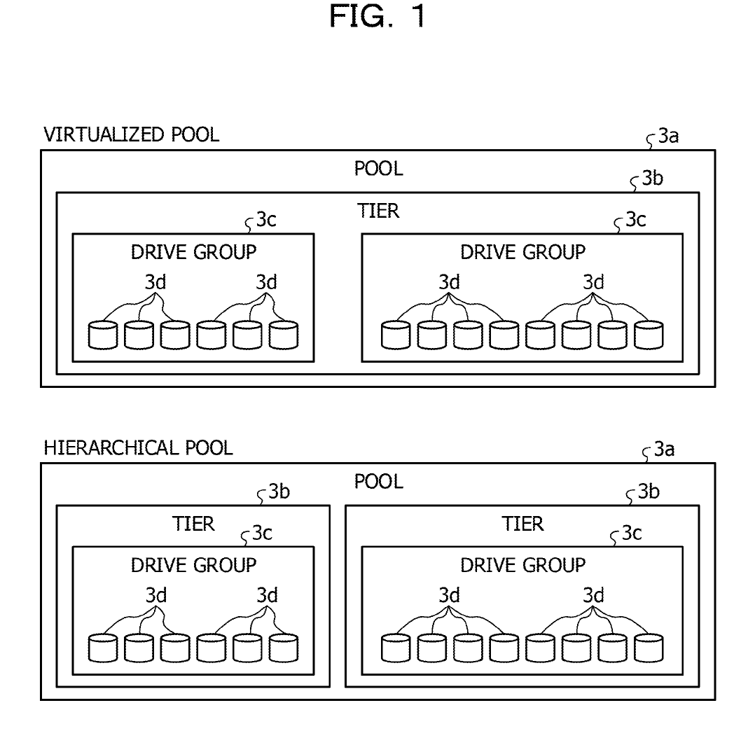

First, a data management method of a storage apparatus according to the embodiment will be described using FIGS. 1 to 7. FIG. 1 is a diagram illustrating a storage configuration of a storage apparatus according to the embodiment. As illustrated in FIG. 1, the storage apparatus according to the embodiment manages multiple SSDs 3d as a pool 3a based on RAID (redundant arrays of inexpensive disks) 6. Also, the storage apparatus according to the embodiment includes multiple pools 3a.

The pool 3a includes a virtualized pool and a hierarchical pool. The virtualized pool include one tier 3b, while the hierarchical pool includes two or more tiers 3b. The tier 3b includes one or more drive groups 3c. The drive group 3c is a group of the SSDs 3d, and includes from 6 to 24 SSDs 3d. For example, among six SSDs 3d that store a single stripe, three are used for data storage, two are used for parity storage, and one is used as a hot spare. Note that the drive group 3c may include 25 or more SSDs 3d.

The storage apparatus according to the embodiment manages data in units of RAID units. The units of physical allocation for thin provisioning are typically chunks of fixed size, in which one chunk corresponds to one RAID unit. In the following description, chunks are called RAID units. A RAID unit is a contiguous 24 MB physical region allocated from the pool 3a. The storage apparatus according to the embodiment buffers data in main memory in units of RAID units, and appends the data to the SSDs 3d.

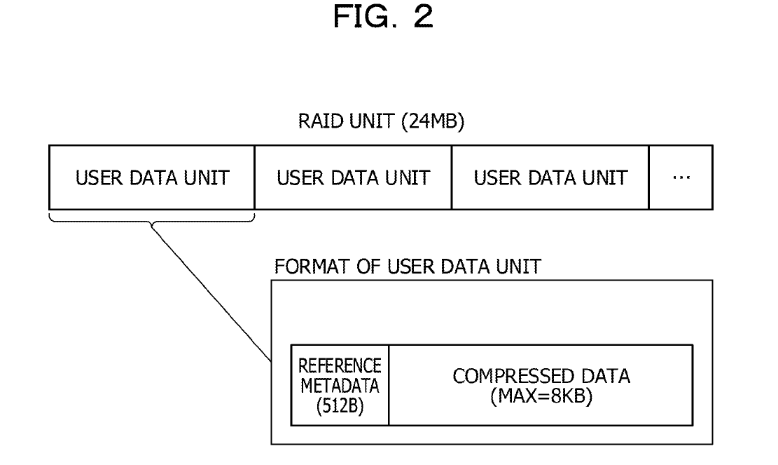

FIG. 2 is a diagram illustrating the format of a RAID unit. As illustrated in FIG. 2, a RAID unit includes multiple user data units (also called data logs). A user data unit includes reference metadata and compressed data. The reference metadata is management data regarding data written to the SSDs 3d.

The compressed data is compressed data written to the SSDs 3d. The maximum size of the data is 8 kilobytes (KB). Assuming a compression rate of 50%, when 24 MB÷4.5 KB÷5461 data units accumulate, for example, the storage apparatus according to the embodiment writes a RAID unit to the SSDs 3d.

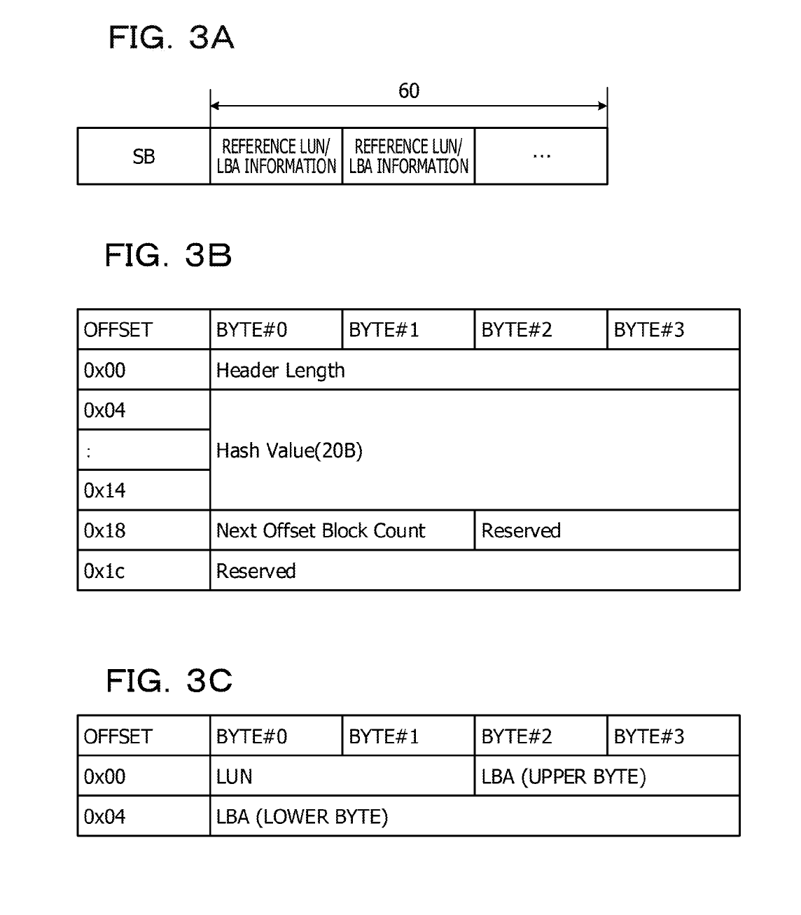

FIGS. 3A to 3C are diagrams illustrating the format of the reference metadata. As illustrated in FIG. 3A, in the reference metadata, there is reserved a region of storage volume enabling the writing of a super block (SB) and up to 60 referents, namely reference logical unit number (LUN)/logical block address (LBA) information. The size of the SB is 32 bytes (B), and the size of the reference metadata is 512 bytes (B). The size of each piece of reference LUN/LBA information is 8 bytes (B). In the reference metadata, when a new referent is created due to deduplication, the reference is added, and the reference metadata is updated. However, even in the case in which a referent is removed due to the updating of data, the reference LUN/LBA information is retained without being deleted. Reference LUN/LBA information which has become invalid is recovered by garbage collection.

As illustrated in FIG. 3B, the SB includes a 4B header length field, a 20B hash value field, and a 2B next offset block count field. The header length is the length of the reference metadata. The hash value is a hash value of the data, and is used for deduplication. The next offset block count is the position of the reference LUN/LBA information stored next. Note that the reserved field is for future expansion.

As illustrated in FIG. 3C, the reference LUN/LBA information includes a 2B LUN and a 6B LBA.

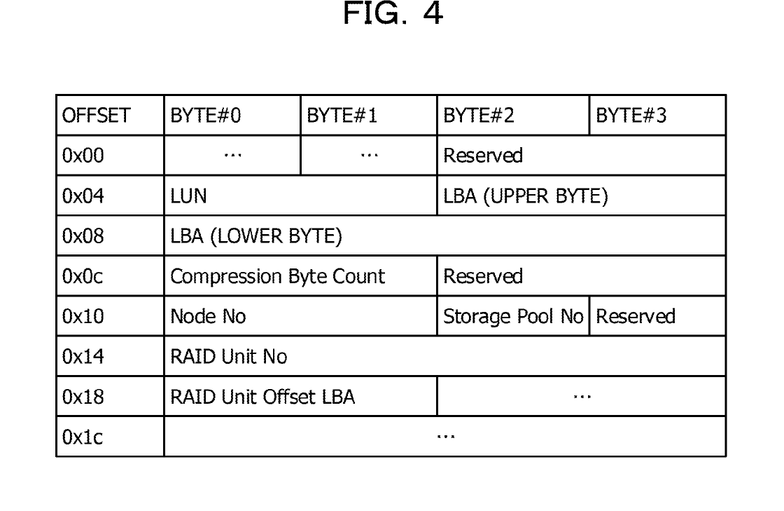

Also, the storage apparatus according to the embodiment uses logical/physical conversion information, namely logical/physical metadata, to manage correspondence relationships between logical addresses and physical addresses. FIG. 4 is a diagram illustrating the format of the logical/physical metadata. The storage apparatus according to the embodiment manages the information illustrated in FIG. 4 for every 8 KB of data.

As illustrated in FIG. 4, the size of the logical/physical metadata is 32B. The logical/physical metadata includes a 2B LUN and a 6B LBA as a logical address of data. Also, the logical/physical metadata includes a 2B compression byte count field as a byte count of the compressed data.

Also, the logical/physical metadata includes a 2B node number (no.) field, a 1B storage pool no. field, a 4B RAID unit no. field, and a 2B RAID unit offset LBA field as a physical address.

The node no. is a number for identifying the storage control apparatus in charge of the pool 3a to which the RAID unit storing the data unit belongs. Note that the storage control apparatus will be described later. The storage pool no. is a number for identifying the pool 3a to which the RAID unit storing the data unit belongs. The RAID unit no. is a number for identifying the RAID unit storing the data unit. The RAID unit offset LBA is an address of the data unit within the RAID unit.

The storage apparatus according to the embodiment manages logical/physical metadata in units of RAID units. The storage apparatus according to the embodiment buffers logical/physical metadata in main memory in units of RAID units, and when 786432 entries accumulate in the buffer, for example, the storage apparatus appends and bulk-writes the logical/physical metadata to the SSDs 3d. For this reason, the storage apparatus according to the embodiment manages information indicating the location of the logical/physical metadata by a meta-metadata scheme.

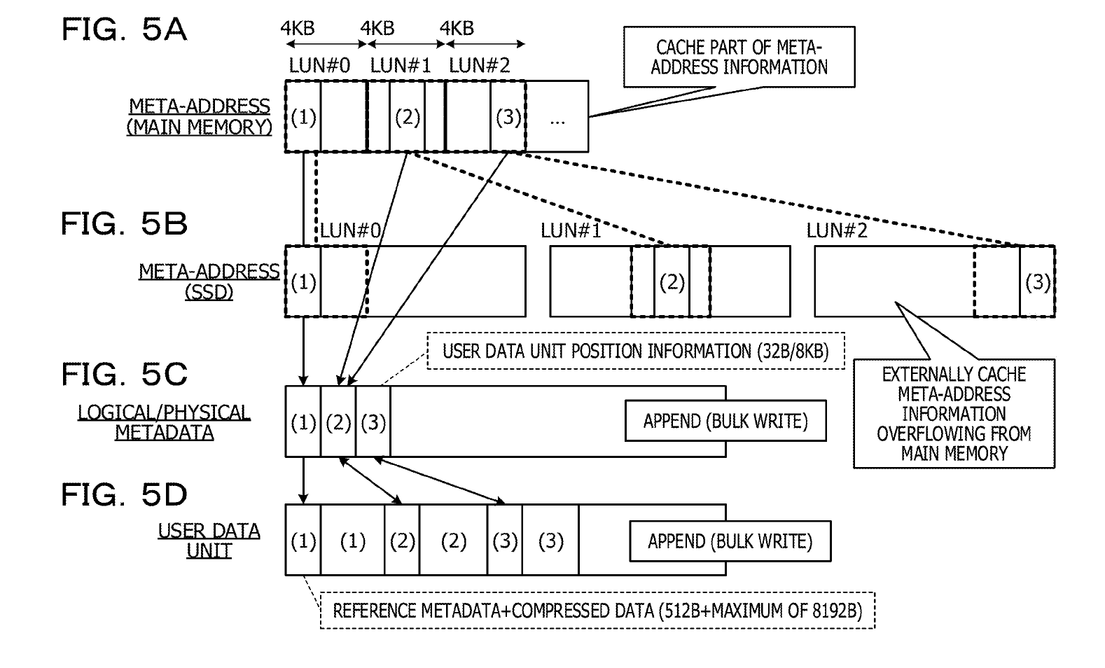

FIGS. 5A to 5D are diagrams for describing a meta-metadata scheme according to the embodiment. As illustrated in FIG. 5D, the data units labeled (1), (2), (3), and so on are bulk-written to the SSDs 3d in units of RAID units. Additionally, as illustrated in FIG. 5C, logical/physical metadata indicating the positions of the data units are bulk-written to the SSDs 3d in units of RAID units.

In addition, as illustrated in FIG. 5A, the storage apparatus according to the embodiment manages the position of the logical/physical metadata in main memory by using a meta-address for each LUN/LBA. However, as illustrated in FIG. 5B, meta-address information overflowing from the main memory is saved in an external cache (secondary cache). Herein, the external cache refers to a cache on the SSDs 3d.

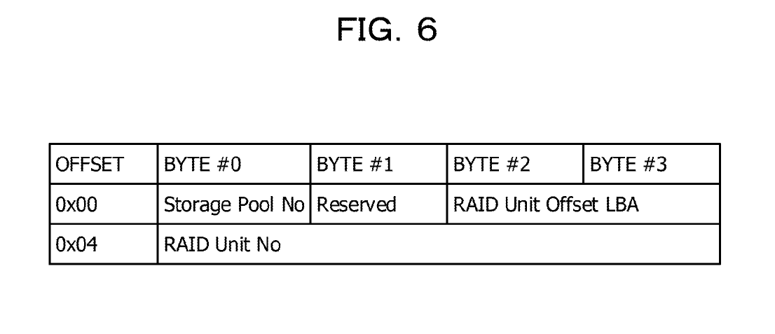

FIG. 6 is a diagram illustrating the format of the meta-address. As illustrated in FIG. 6, the size of the meta-address is 8B. The meta-address includes a storage pool no., a RAID unit offset LBA, and a RAID unit no. The meta-address is a physical address indicating the storage position of logical/physical metadata on the SSDs 3d.

The storage pool no. is a number for identifying the pool 3a to which the RAID unit storing the logical/physical metadata belongs. The RAID unit offset LBA is an address of the logical/physical metadata within the RAID unit. The RAID unit no. is a number for identifying the RAID unit storing the logical/physical metadata.

512 meta-addresses are managed as a meta-address page (4 KB), and cached in the main memory in units of meta-address pages. Also, the meta-address information is stored in units of RAID units from the beginning of the SSDs 3d, for example.

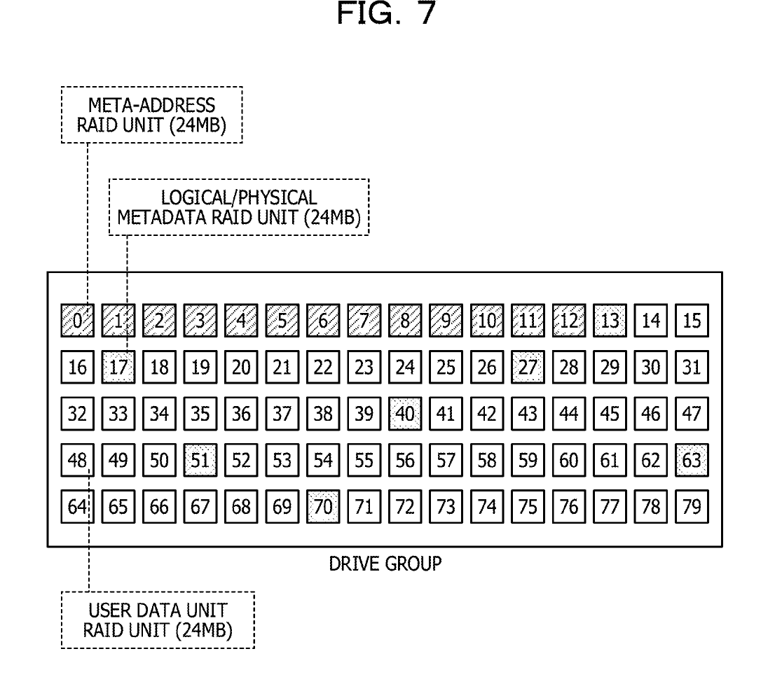

FIG. 7 is a diagram illustrating an exemplary arrangement of RAID units in a drive group 3c. As illustrated in FIG. 7, the RAID units that store meta-addresses are arranged at the beginning. In FIG. 7, the RAID units with numbers from “0” to “12” are the RAID units that store meta-addresses. When there is an meta-address update, the RAID unit storing the meta-address is overwritten and saved.

The RAID units that store the logical/physical metadata and the RAID units that store the user data units are written out sequentially to the drive group when the respective buffer becomes full. In FIG. 7, in the drive group, the RAID units with the numbers “13”, “17”, “27”, “40”, “51”, “63”, and “70” are the RAID units that store the logical/physical metadata, while the other RAID units are the RAID units that store the user data units.

By holding a minimum level of information in main memory by the meta-metadata scheme, and appending and bulk-writing the logical/physical metadata and the data units to the SSDs 3d, the storage apparatus according to the embodiment is able to decrease the number of writes to the SSDs 3d.

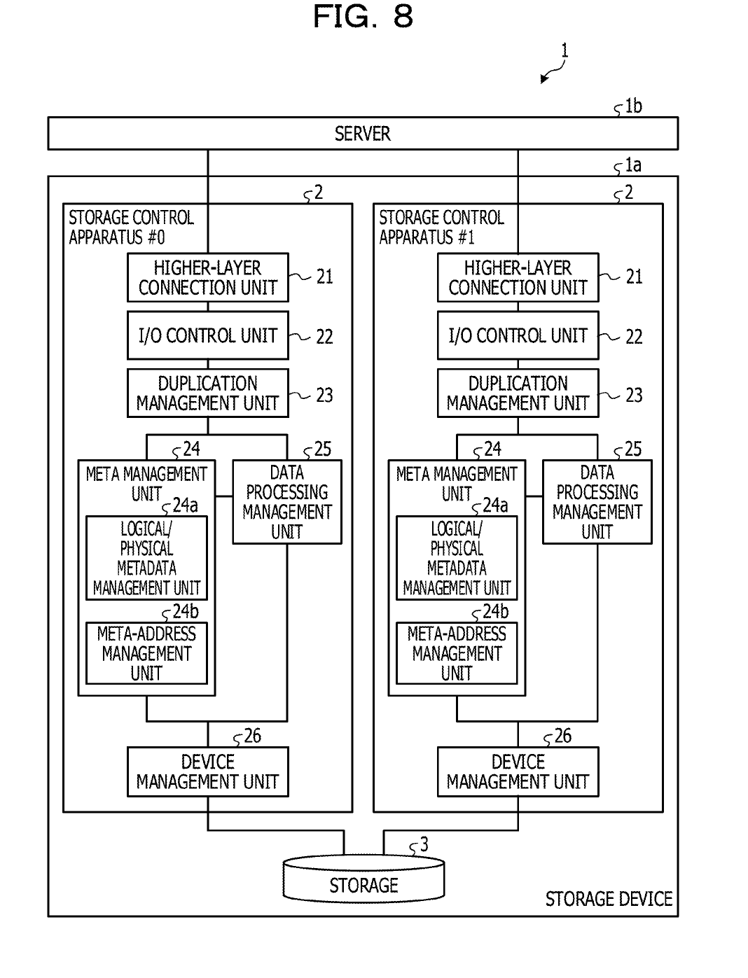

Next, the configuration of the information processing system according to the embodiment will be described. FIG. 8 is a diagram illustrating the configuration of the information processing system according to the embodiment. As illustrated in FIG. 8, the information processing system 1 according to the embodiment includes a storage apparatus 1a and a server 1b. The storage apparatus 1a is an apparatus that stores data used by the server 1b. The server 1b is an information processing apparatus that performs work such as information processing. The storage apparatus 1a and the server 1b are connected by Fibre Channel (FC) and Internet Small Computer System Interface (iSCSI).

The storage apparatus 1a includes storage control apparatus 2 that control the storage apparatus 1a, and storage (a storage device) 3 that stores data. Herein, the storage 3 is a collection of multiple storage apparatus (SSDs) 3d.

Note that in FIG. 8, the storage apparatus 1a includes two storage control apparatus 2 labeled the storage control apparatus #0 and the storage control apparatus #1, but the storage apparatus 1a may include three or more storage control apparatus 2. Also, in FIG. 8, the information processing system 1 includes one server 1b, but the information processing system 1 may include two or more servers 1b.

The storage control apparatus 2 take partial charge of the management of the storage 3, and are in charge of one or more pools 3a. The storage control apparatus 2 include a higher-layer connection unit 21, an I/O control unit 22, a duplication management unit 23, a metadata management unit 24, a data processing management unit 25, and a device management unit 26.

The higher-layer connection unit 21 delivers information between an FC driver and an iSCSI driver, and the I/O control unit 22. The I/O control unit 22 manages data in cache memory. The duplication management unit 23 controls data deduplication/reconstruction to thereby manage unique data stored inside the storage apparatus 1a.

The metadata management unit 24 manages meta-addresses and logical/physical metadata. Also, the metadata management unit 24 uses the meta-addresses and logical/physical metadata to perform a conversion process between logical addresses used to identify data in a virtual volume, and physical addresses indicating the positions where data is stored on the SSDs 3d.

The metadata management unit 24 includes a logical/physical metadata management unit 24a and a meta-address management unit 24b. The logical/physical metadata management unit 24a manages logical/physical metadata related to address conversion information that associates logical addresses and physical addresses. The logical/physical metadata management unit 24a requests the data processing management unit 25 to write logical/physical metadata to the SSDs 3d, and also read out logical/physical metadata from the SSDs 3d. The logical/physical metadata management unit 24a specifies the storage location of logical/physical metadata using a meta-address.

The meta-address management unit 24b manages meta-addresses. The meta-address management unit 24b requests the device management unit 26 to write meta-addresses to the external cache (secondary cache), and also to read out meta-addresses from the external cache.

The data processing management unit 25 manages user data in contiguous user data units, and appends and bulk-writes user data to the SSDs 3d in units of RAID units. Also, the data processing management unit 25 compresses and decompresses data, and generates reference metadata. However, when data is updated, the data processing management unit 25 maintains the reference metadata, without updating the reference metadata included in the user data unit corresponding to the old data.

Also, the data processing management unit 25 appends and bulk-writes logical/physical metadata to the SSDs 3d in units of RAID units. In the writing of the logical/physical metadata, 16 entries of logical/physical metadata are appended to one small block (512B), and thus the data processing management unit 25 manages the logical/physical metadata so that data with the same LUN and LBA does not exist within the same small block.

By managing the logical/physical metadata so that data with the same LUN and LBA does not exist within the same small block, the data processing management unit 25 is able to find the LUN and LBA with the RAID unit number and the LBA within the RAID unit. Note that to distinguish from the 1 MB blocks which are the units of data deletion, herein, the 512B blocks are called small blocks.

Also, when the readout of logical/physical metadata from the metadata management unit 24 is requested, the data processing management unit 25 responds by searching for the LUN and LBA of the referent from the designated small block in the metadata management unit 24.

The data processing management unit 25 buffers write data in a buffer in main memory, namely a write buffer, and writes out to the SSDs 3d when a fixed threshold value is exceeded. The data processing management unit 25 manages the physical space on the pools 3a, and arranges the RAID units. The device management unit 26 writes RAID units to the storage 3.

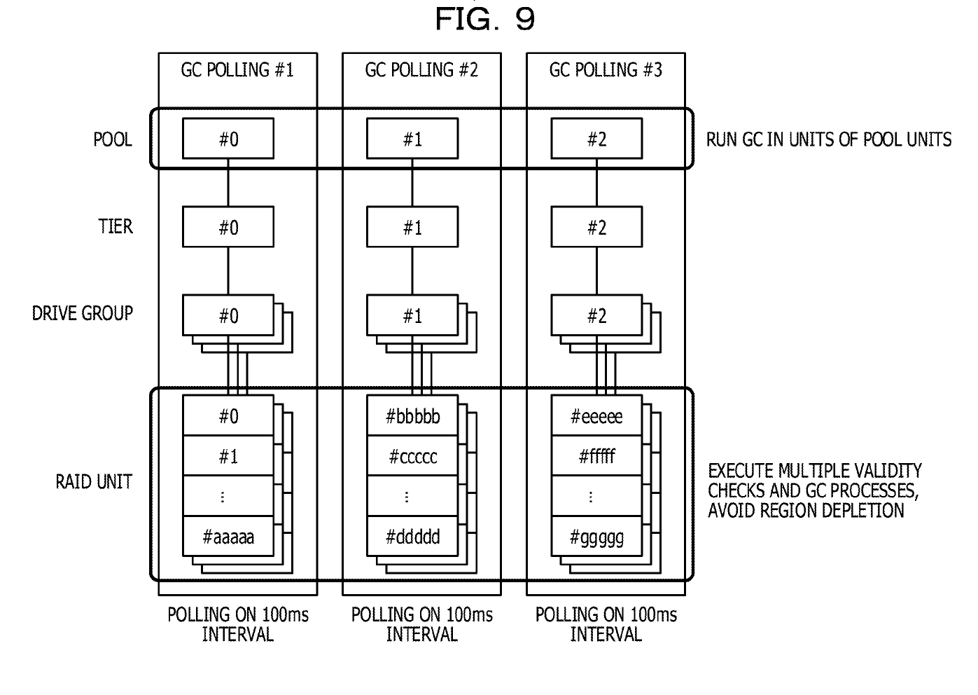

The data processing management unit 25 polls garbage collection (GC) in units of pools 3a. FIG. 9 is a diagram for describing GC polling in units of pools 3a. In FIG. 9, for each of three pools 3a labeled pool #0, pool #1, and pool #2, corresponding GC polling, namely GC polling #1, GC polling #2, and GC polling #3, is performed. Also, in FIG. 9, each pool 3a has a single tier 3b. Each tier 3b includes multiple drive groups 3c, and each drive group 3c includes multiple RAID units.

The data processing management unit 25 performs GC targeting the user data units and the logical/physical metadata. The data processing management unit 25 polls GC for every pool 3a on a 100 ms interval, for example. Also, the data processing management unit 25 generates a thread for each RAID unit to thereby perform GC in parallel with respect to multiple RAID units. The number of generated threads is hereinafter called the multiplicity. The polling interval is decided to minimize the influence of GC on I/O performance. The multiplicity is decided based on a balance between the influence on I/O performance and region depletion.

The data processing management unit 25 reads the data of a RAID unit into a read buffer, checks whether or not the data is valid for every user data unit or logical/physical metadata, appends only the valid data to a write buffer, and then bulk-writes to the storage 3. Herein, valid data refers to data which is in use, whereas invalid data refers to data which is not in use.

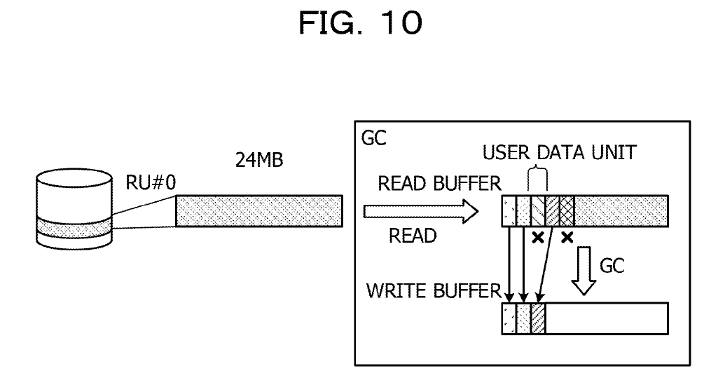

FIG. 10 is a diagram for describing the appending of valid data. In FIG. 10, the RAID unit is a RAID unit used for user data units. As illustrated in FIG. 10, the data processing management unit 25 reads the RAID unit labeled RU#0 into a read buffer, checks whether or not the data is valid for every user data unit, and appends only the valid data to a write buffer.

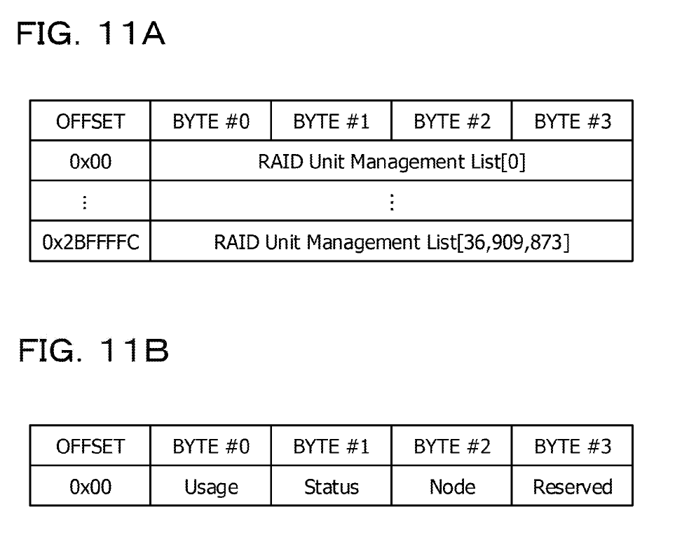

The data processing management unit 25 uses an RU management table to manage whether a RAID unit is used for user data units or for logical/physical metadata. In FIG. 11A illustrates the format of the RU management table. As illustrated in FIG. 11A, in the RU management table, information about each RAID unit is managed as a 4B RAID unit management list.

In FIG. 11B illustrates the format of the RAID unit management list. As illustrated in FIG. 11B, the RAID unit management list includes a 1B usage field, a 1B status field, and a 1B node field.

The usage field indicates whether the RAID unit is used for user data units, used for logical/physical metadata, or outside the GC jurisdiction. The default value is “outside GC jurisdiction”, and when the RAID unit is captured for use with user data units, the usage is set to “user data units”, whereas when the RAID unit is captured for use with logical/physical metadata, the usage is set to “logical/physical metadata”. Also, when the RAID unit is released, the usage is set to “outside GC jurisdiction”.

The status field indicates the allocation status of the RAID unit, which may be “unallocated”, “allocated”, “written”, or “GC in progress”. The default value is “unallocated”. “Unallocated” is set when the RAID unit is released. “Allocated” is set when the RAID unit is captured. “Written” is set when writing to the RAID unit. “GC in progress” is set when GC starts.

The node is a number for identifying the storage control apparatus 2 in charge of the RAID unit. The node is set when the RAID unit is captured.

Also, the data processing management unit 25 communicates with the data processing management unit 25 of other storage control apparatus 2. Also, the data processing management unit 25 calculates the invalid data ratio by using the reference metadata to determine whether or not the user data units included in a RAID unit are valid. In addition, the data processing management unit 25 performs GC on RAID units whose invalid data ratio is equal to or greater than a threshold value (for example, 50%).

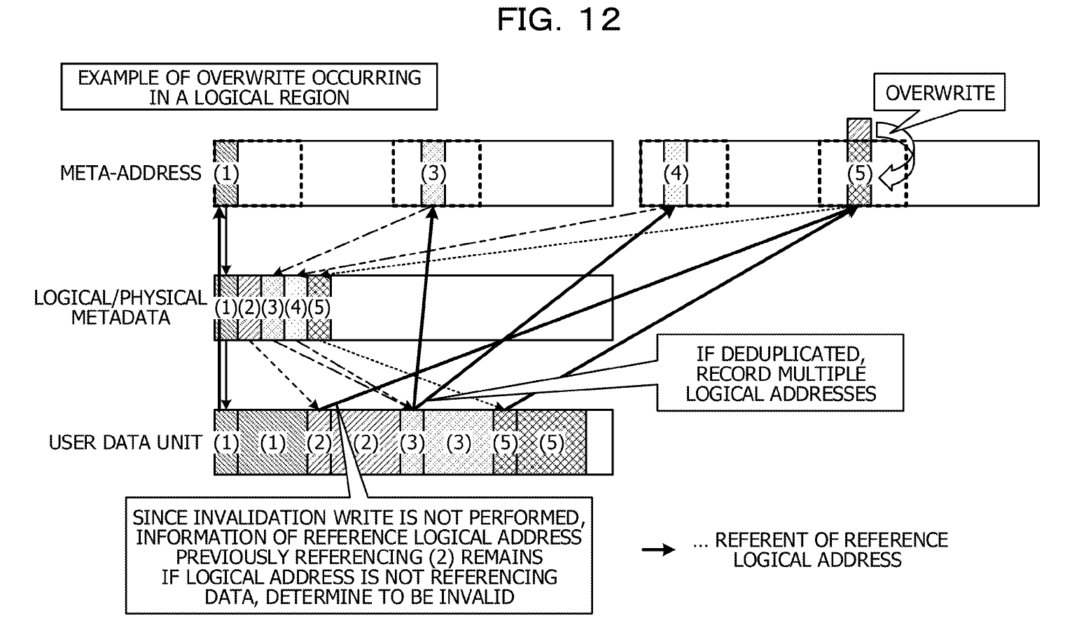

FIG. 12 is a diagram for describing a method of determining data validity using reference metadata. FIG. 12 illustrates a case in which, in the state in which the data labeled (1), (2), (3), and (4) is stored in the storage 3, the data labeled (2) is overwritten by the data labeled (5). Also, the user data units of (3) and (4) are the same. The arrows in bold indicate the referent designated by a reference logical address. Herein, the reference logical address denotes a logical address included in the reference metadata.

As illustrated in FIG. 12, (2) is overwritten by (5) and invalidated, but since an invalidation write that invalidates the data is not performed, the information of the reference logical address referencing (2) still remains in the reference metadata. Consequently, if all of the physical addresses associated with all of the reference logical addresses by the logical/physical metadata are different from the physical address of (2), the data processing management unit 25 determines that (2) is invalid.

In FIG. 12, since the meta-address of (2) is overwritten by the meta-address of (5), the physical address associated with the reference logical address of (2) by the logical/physical metadata is the physical address of the user data unit of (5), which is different from the physical address of the user data unit of (2). Consequently, the data processing management unit 25 determines that (2) is invalid.

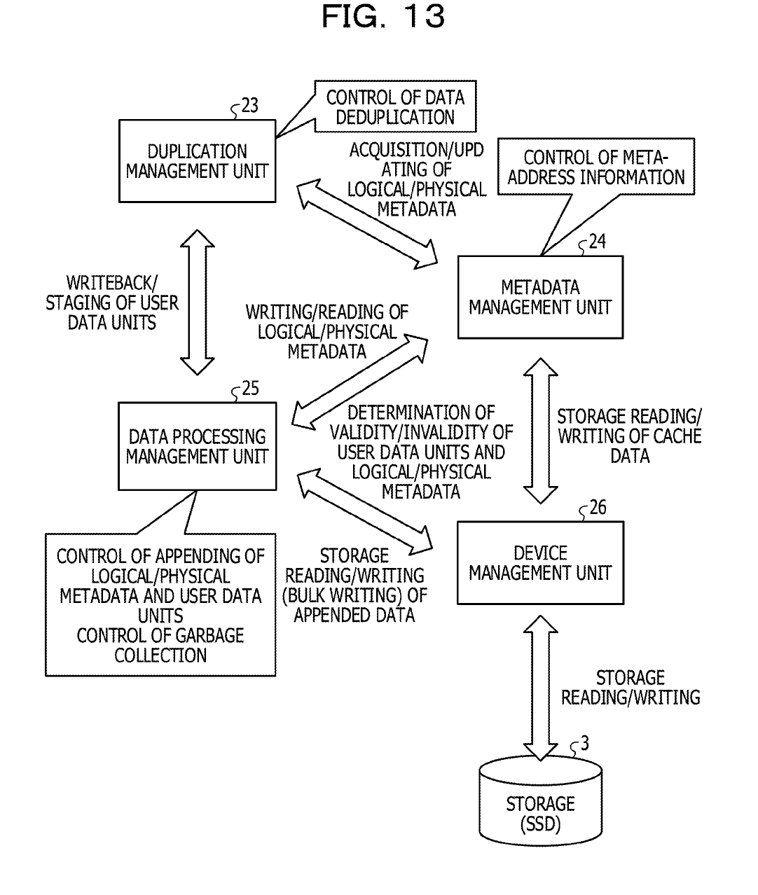

FIG. 13 is a diagram illustrating relationships among functional units. As illustrated in FIG. 13, between the duplication management unit 23 and the metadata management unit 24, logical/physical metadata acquisition and updating are performed. Between the duplication management unit 23 and the data processing management unit 25, user data unit writeback and staging are performed. Herein writeback refers to writing data to the storage 3, while staging refers to reading out data from the storage 3.

Between the metadata management unit 24 and the data processing management unit 25, writes and reads of logical/physical metadata, and the determination of whether or not user data units and logical/physical metadata are valid are performed. Between the data processing management unit 25 and the device management unit 26, storage reads and storage writes of appended data are performed. Between the metadata management unit 24 and the device management unit 26, storage reads and storage writes of the external cache are performed. Between the device management unit 26 and the storage 3, storage reads and storage writes are performed.

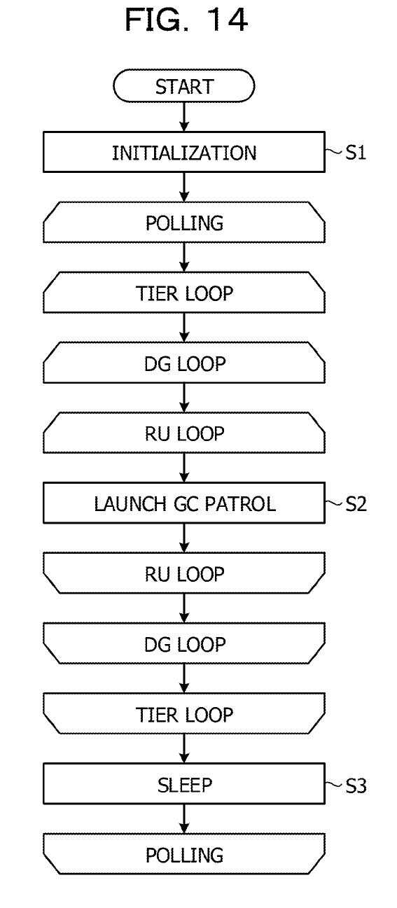

Next, the flow of GC polling will be described. FIG. 14 is a flowchart illustrating the flow of GC polling. As illustrated in FIG. 14, after initialization (step S1), the data processing management unit 25 repeats polling by launching a GC patrol (step S2) for every RAID unit (RU), in every drive group (DG) 3c, in every tier 3b of a single pool 3a.

Regarding RAID units used for user data units, the data processing management unit 25 generates a number of patrol threads equal to the multiplicity, and performs GC processes in parallel. On the other hand, regarding RAID units used for logical/physical metadata, the data processing management unit 25 generates a single patrol thread to perform the GC process. Note that the data processing management unit 25 performs exclusive control so that a patrol thread for a RAID unit used for user data units and a patrol thread for a RAID unit used for logical/physical metadata do not operate at the same time.

Subsequently, when the process is finished for all tiers 3b, the data processing management unit 25 puts GC to sleep so that the polling interval becomes 100 ms (step S3). Note that the process in FIG. 14 is performed on each pool 3a.

The patrol thread calculates the invalid data ratio of the RAID units, and performs a GC process on a RAID unit whose invalid data ratio is equal to or greater than a threshold value. Herein, the GC process refers to a process such as reading a RAID unit into a read buffer and writing only the valid data to a write buffer.

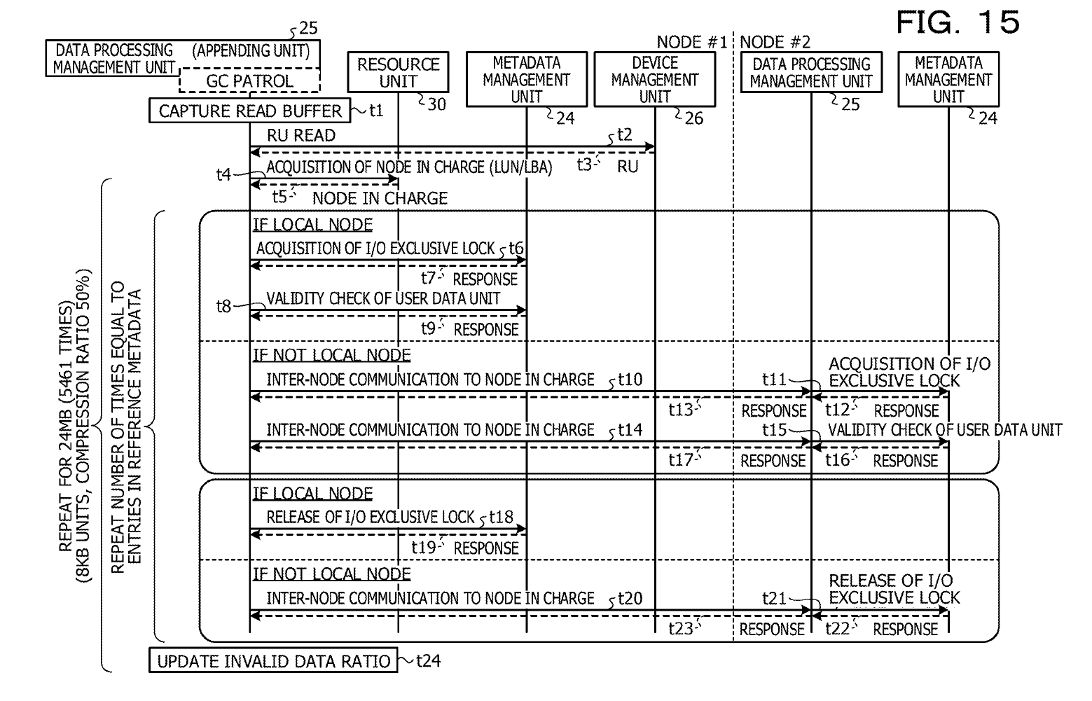

Next, the sequence of a process of computing the invalid data ratio will be described. FIG. 15 is a diagram illustrating the sequence of the process of computing the invalid data ratio. Note that in FIG. 15, the node is the storage control apparatus 2. Also, the resource unit 30 is positioned between the higher-layer connection unit 21 and the I/O control unit 22, and allocates SSDs 3d to nodes and the like.

As illustrated in FIG. 15, the data processing management unit 25 captures a read buffer (step t1). Subsequently, the data processing management unit 25 requests the device management unit 26 to read a RAID unit (RU) (step t2), and receives the RU in response (step t3). Subsequently, the data processing management unit 25 selects one user data unit, specifies the reference LUN/LBA information included in the reference metadata of the selected user data unit to request the resource unit 30 to acquire the node in charge (step t4), and obtains the node in charge in response (step t5).

Subsequently, in the case in which the node in charge is the local node, the data processing management unit 25 requests the metadata management unit 24 for the acquisition of an I/O exclusive lock (step t6), and receives a response (step t7). Subsequently, the data processing management unit 25 requests the metadata management unit 24 for a validity check of a user data unit (step t8), and receives a check result (step t9).

On the other hand, in the case in which the node in charge is not the local node, the data processing management unit 25 requests the node in charge for the acquisition of an I/O exclusive lock through inter-node communication (step t10), and the data processing management unit 25 of the node in charge requests the metadata management unit 24 of the node in charge for the acquisition of an I/O exclusive lock (step t11). Subsequently, the metadata management unit 24 of the node in charge responds (step t12), and the data processing management unit 25 of the node in charge responds to the requesting node (step t13).

Subsequently, the data processing management unit 25 requests the node in charge for a validity check of the user data unit through inter-node communication (step t14), and the data processing management unit 25 of the node in charge requests the metadata management unit 24 of the node in charge for a validity check of the user data unit (step t15). Subsequently, the metadata management unit 24 of the node in charge responds (step t16), and the data processing management unit 25 of the node in charge responds to the requesting node (step t17).

Subsequently, in the case in which the node in charge is the local node, the data processing management unit 25 requests the metadata management unit 24 for the release of the I/O exclusive lock (step t18), and receives a response from the metadata management unit 24 (step t19). On the other hand, in the case in which the node in charge is not the local node, the data processing management unit 25 requests the node in charge for the release of the I/O exclusive lock through inter-node communication (step t20), and the data processing management unit 25 of the node in charge requests the metadata management unit 24 of the node in charge for the release of the I/O exclusive lock (step t21). Subsequently, the metadata management unit 24 of the node in charge responds (step t22), and the data processing management unit 25 of the node in charge responds to the requesting node (step t23).

The data processing management unit 25 repeats the process from step t4 to step t23 a number of times equal to the number of entries in the reference metadata. Subsequently, the data processing management unit 25 updates the invalid data ratio (step t24). Note that for a single user data unit, the user data unit is invalid in the case in which all of the reference LUN/LBA information included in the reference metadata is invalid, and the user data unit is valid in the case in which at least entry of the reference LUN/LBA information included in the reference metadata is valid. In addition, the data processing management unit 25 repeats the process from step t4 to step t24 5461 times.

In this way, by requesting the metadata management unit 24 for a validity check of a user data unit with respect to all logical addresses included in the reference metadata, the data processing management unit 25 is able to determine the validity of each user data unit.

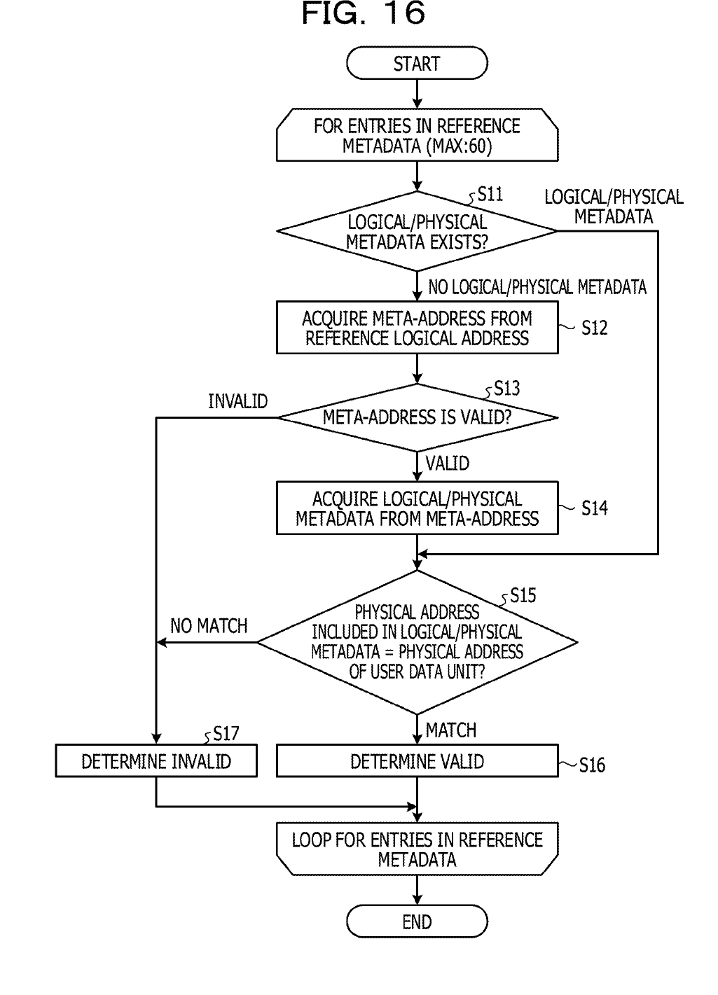

Next, the flow of the validity check process for a user data unit will be described. FIG. 16 is a flowchart illustrating the flow of the validity check process for a user data unit. Note that part of the information of the logical/physical metadata is cached in main memory. As illustrated in FIG. 16, the data processing management unit 25 repeats the process from step S11 to step S17 a number of times equal to the number of entries in the reference metadata.

In other words, the data processing management unit 25 searches the cached logical/physical metadata for the reference LUN/LBA information of a user data unit, and determines whether or not logical/physical metadata exists (step S11). Subsequently, if logical/physical metadata exists, the data processing management unit 25 proceeds to step S15.

On the other hand, if logical/physical metadata does not exist on the cache, the data processing management unit 25 acquires a meta-address from the reference logical address in the reference LUN/LBA information (step S12), and determines whether or not the meta-address is valid (step S13). Subsequently, in the case in which the meta-address is not valid, the data processing management unit 25 proceeds to step S17.

On the other hand, in the case in which the meta-address is valid, the data processing management unit 25 acquires the logical/physical metadata from the meta-address (step S14), and determines whether or not the physical address included in the logical/physical metadata and the physical address of the user data unit are the same (step S15).

Subsequently, in the case in which the physical address included in the logical/physical metadata and the physical address of the user data unit are the same, the data processing management unit 25 determines that the logical/physical metadata is valid (step S16), whereas in the case in which the physical addresses are not the same, the data processing management unit 25 determines that the logical/physical metadata is invalid (step S17). Note that in the case of determining that the reference logical addresses in all entries of the reference metadata are invalid, the data processing management unit 25 determines that the user data unit is invalid, whereas in the case of determining that at least one of the reference logical addresses is invalid, the data processing management unit 25 determines that the user data unit is valid.

In this way, by using the reference logical addresses to perform a validity check on a user data unit, the data processing management unit 25 is able to reduce the processing load of the validity check on a user data unit.

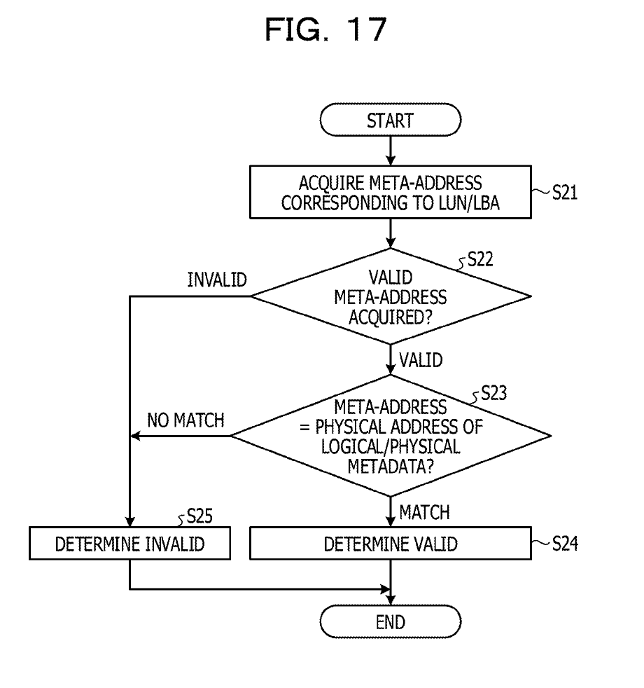

Next, the flow of the validity check process for logical/physical metadata will be described. FIG. 17 is a flowchart illustrating the flow of the validity check process for logical/physical metadata. As illustrated in FIG. 17, the data processing management unit 25 acquires the meta-address corresponding to the LUN and LBA included in the logical/physical metadata (step S21), and determines whether or not a valid meta-address has been acquired (step S22).

Subsequently, in the case of acquiring a valid meta-address, the data processing management unit 25 determines whether or not the meta-address and the physical address of the logical/physical metadata match (step S23). Subsequently, in the case in which the two match, the data processing management unit 25 determines that the logical/physical metadata is valid (step S24).

On the other hand, in the case in which the two do not match, or the case in which a valid meta-address is not acquired in step S22, the data processing management unit 25 determines that the logical/physical metadata is invalid (step S25).

In this way, by using the meta-address to perform a validity check of the logical/physical metadata, the data processing management unit 25 is able to specify the logical/physical metadata which has become invalid.

As described above, in the embodiment, the logical/physical metadata management unit 24a manages information about logical/physical metadata that associates logical addresses and physical addresses of data. Additionally, the data processing management unit 25 appends and bulk-writes user data units to the storage 3, and in the case in which data is updated, retains the reference metadata without invalidating the reference logical addresses of user data units that includes outdated data. Consequently, the storage control apparatus 2 is able to use the reference logical addresses to reduce the load of the validity check process for the user data units.

Also, in the embodiment, the data processing management unit 25 determines whether or not a physical address associated with the reference logical address included in a user data unit by the logical/physical metadata matches the physical address of the user data unit. Subsequently, in the case in which the two match, the data processing management unit 25 determines that the user data unit is valid, whereas in the case in which the two do not match, the data processing management unit 25 determines that the user data unit is invalid. Consequently, the storage control apparatus 2 is able to use the reference logical addresses to perform the validity check for the user data units.

Also, in the embodiment, the meta-address management unit 24b manages meta-addresses. Additionally, the data processing management unit 25 determines whether or not the physical address of the logical/physical metadata and the meta-address associated with the logical address included in the logical/physical metadata match. Subsequently, in the case in which the two match, the data processing management unit 25 determines that the logical/physical metadata is valid, whereas in the case in which the two do not match, the data processing management unit 25 determines that the logical/physical metadata is invalid. Consequently, the storage control apparatus 2 is also able to determine whether or not the logical/physical metadata is valid.

Also, in the embodiment, in the case in which a meta-address associated with the logical address included in the logical/physical metadata does not exist, the logical/physical metadata is determined to be invalid. Consequently, the storage control apparatus 2 is able to determine that the logical/physical metadata related to deleted data is invalid.

Also, in the embodiment, the data processing management unit 25 determines whether or not a certain user data unit is a user data unit managed by the local apparatus, and if the user data unit is not managed by the local apparatus, the data processing management unit 25 requests the storage control apparatus 2 in charge of the relevant user data unit for a validity check of the user data unit. Consequently, the storage control apparatus 2 is able to perform validity checks even on user data units that the local storage control apparatus 2 is not in charge of.

Note that although the embodiment describes the storage control apparatus 2, by realizing the configuration included in the storage control apparatus 2 with software, it is possible to obtain a storage control program having similar functions. Accordingly, a hardware configuration of the storage control apparatus 2 that executes the storage control program will be described.

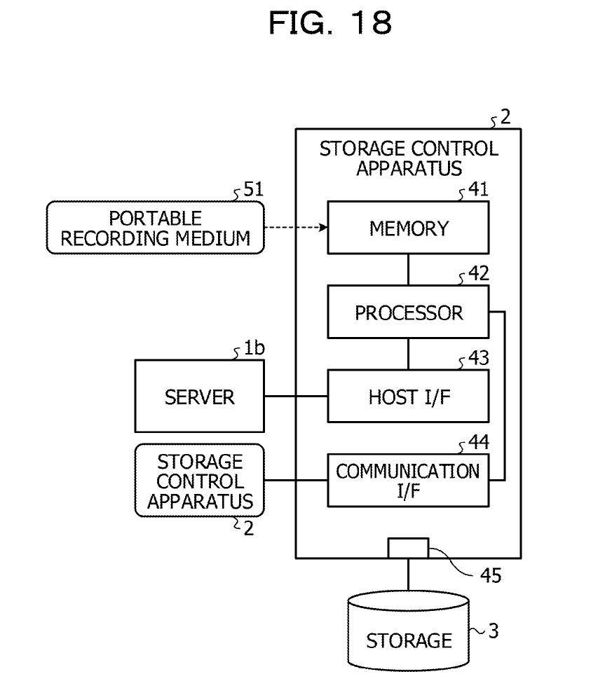

FIG. 18 is a diagram illustrating the hardware configuration of the storage control apparatus 2 that executes the storage control program according to the embodiment. As illustrated in FIG. 18, the storage control apparatus 2 includes memory 41, a processor 42, a host I/F 43, a communication I/F 44, and a connection I/F 45.

The memory 41 is random access memory (RAM) that stores programs, intermediate results obtained during the execution of programs, and the like. The processor 42 is a processing device that reads out and executes programs from the memory 41.

The host I/F 43 is an interface with the server 1b. The communication I/F 44 is an interface for communicating with other storage control apparatus 2. The connection I/F 45 is an interface with the storage 3.

In addition, the storage control program executed in the processor 42 is stored on a portable recording medium 51, and read into the memory 41. Alternatively, the storage control program is stored in databases or the like of a computer system connected through the communication interface 44, read out from these databases, and read into the memory 41.

Also, the embodiment describes a case of using the SSDs 3d as the non-volatile storage media, but the present technology is not limited thereto, and is also similarly applicable to the case of using other non-volatile storage media having device characteristics similar to the SSDs 3d.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control apparatus configured to control a storage device including a storage medium having a limited number of writes, comprising:
a memory; and
a processor coupled to the memory and configured to:
store, in the memory, address conversion information associating logical addresses used for data identification by an information processing apparatus accessing to the storage device, and physical addresses indicating positions where the data is stored on the storage medium,
write the data additionally and collectively to the storage medium, and
when the data is updated, maintain storing a reference logical address associated with the data before updated and the data before updated on the storage medium.

2. The storage control apparatus according to claim 1, wherein
when a physical address associated with the reference logical address by the address conversion information does not match a physical address of the data, the processor determines that the data is invalid data and a target of garbage collection.

3. The storage control apparatus according to claim 2, wherein
the processor
records a physical address indicating a position where the data is appended and bulk-written to the storage medium in the address conversion information in association with the logical address as a meta-address,
appends and bulk-writes the address conversion information to the storage medium, and
when a physical address indicating a position where the address conversion information is appended and bulk-written to the storage medium does not match the meta-address associated with the logical address included in the address conversion information, the processor determines that the address conversion information is invalid and a target of garbage collection.

4. The storage control apparatus according to claim 3, wherein
when a meta-address associated with the logical address included in the address conversion information does not exist, the processor determines that the address conversion information is invalid and a target of garbage collection.

5. The storage control apparatus according to claim 2, wherein
the processor
determines whether or not the data is data managed by the storage control apparatus itself,
when the data is not data managed by the storage control apparatus itself, the processor requests a storage control apparatus in charge of the data to determine whether or not the data is valid, and
when a response indicating that the data is not valid is received, the processor determines that the data is a target of garbage collection.

6. A storage control method for a storage control apparatus including a memory and a processor coupled to the memory, the storage control apparatus configured to control a storage device including a storage medium having a limited number of writes, comprising:
storing, in the memory, address conversion information associating logical addresses used for data identification by an information processing apparatus accessing to the storage device, and physical addresses indicating positions where the data is stored on the storage medium;
writing the data additionally and collectively to the storage medium; and
when the data is updated, maintaining storing a reference logical address associated with the data before updated and the data before updated on the storage medium.
